(19) United States
(12) Patent Application Publication
(10) Pub. No.: US 2006/0045952 A1
(43) Pub. Date: Mar. 2, 2006

(54) Device and method for producing fondant

(75) Inventors: Jose De Vilchez, Hannover (DE); Bernhard Koch, Hannover (DE); Dieter Rocznik, Seelze (DE)

Correspondence Address: WILLIAM COLLARD;COLLARD & ROE, P.C., 1077 NORTHERN BOULEVARD, ROSLYN, NY, 11576, US

(73) Assignee: Klockner Hansel Processing GmbH, Hannover (DE)

(21) Appl. No.: 11/217,220

(22) Filed: Sep. 1, 2005

(30) Foreign Application Priority Data
Sep. 2, 2004 (DE) 10 2004 042 921.9

(51) Int. Cl. A23L 3/36

(52) U.S. Cl. 426/524

(57) ABSTRACT

A device for producing fondant and a method for producing fondant are provided. The device is suitable for the continuous production of fondant from a saccharide-containing solution, having a temperature above or in the range of the saturation point, i.e. boiling temperature. The device is formed from a transport screw having a cooled stator and a cooled rotor for cooling the saccharide-containing solution and for inducing crystallization.

### CROSS REFERENCE TO RELATED APPLICATIONS

Applicants claim priority under 35 U.S.C. §119 of German Application No. 10 2004 042 921.9 filed Sep. 2, 2004

### BACKGROUND OF THE INVENTION

1. Field of the Invention

The present invention relates to a device for the continuous production of fondant and to a method for the continuous production of fondant.

2. The Prior Art

Fondant is a two-phase system of saccharose crystals and saturated saccharide solution. Production takes place from the ingredients saccharose, glucose syrup or invert sugar, optionally sorbitol. These ingredients are mixed in water to produce a slurry, or partially dissolved. This slurry is concentrated to a dry substance content of approximately 80 to 92%, preferably 88 to 90%, by means of boiling, which corresponds to a boiling temperature of approximately 110 to 125 degrees C., in the preferred range 118 to 121 degrees C., at atmospheric pressure. In this connection, the hot solution that contains saccharide has a dry substance content that corresponds to that of a super-saturated solution when it cools.

Subsequent to boiling, the hot saccharide solution is stirred, while cooling it strongly, and intensively tabled, in order to promote the formation of saccharose crystals having small dimensions, so that the end product consists of a mixture of saturated saccharide solution and saccharose crystals, which stands in equilibrium at room temperature and is stable.

The cooling and mixing for producing the desired crystal sizes, also called tabling, can be implemented technically by means of various methods. According to “Zucker und Zuckerwaren” [Sugar and confectionery], Hoffmann, Mauch, Untze 2002, B. Behr's Verlag, Hamburg, it is desirable that the dimensions of the sugar crystals be present in a range of less than 30 μm, with the main amount in a range around 10 μm, and that only a small proportion be even smaller. Above a grain size of 30 μm, particles are perceived as being rough when they are consumed. Crystals having very small grain sizes are not without problems during further processing because they can go completely into solution when the fondant is heated, and are no longer available as crystallization seeds during re-crystallization due to renewed cooling, so that existing crystals grow more strongly and the maximal grain size is increased.

The grain size spectrum of the fondant is stable when the solid phase of the saccharose crystals is in equilibrium with the sugar-saturated liquid phase. This equilibrium is stable at a temperature below approximately 65 degrees C. to room temperature. Accordingly, exit temperatures of fondant during machine production of below 65 degrees C., particularly below approximately 60 degrees C., are preferred.

The ratio of liquid phase to solid phase of the finished fondant depends on the water content of the mixture. The water content can be adjusted by means of the ratio of boiling temperature and pressure that is applied during evaporation of the water vapors.

The devices currently used in production for producing fondant are presented, in summary form, in “Zucker und Zuckerwaren,” Hoffmann (op. cit.).

Thus, a system developed by Baker Perkins is known in which the boiled sugar solution, which is still hot, and has a dry substance content that corresponds to super-saturation at low temperatures, is passed over a cylindrical cooling drum and transformed to the status of super-saturation. Subsequently, the super-saturated mass is passed into a so-called tabling screw in which crystallization is induced. The tabling screw is water-cooled and disposed horizontally. The entry and exit openings of the tabling screw are open towards the atmosphere, the fondant mass that is discharged can run into a tempering container that lies underneath.

According to another method developed by the Otto Hänsel company, the boiled sugar solution is drawn into a vacuum chamber after the water vapors have been removed, under atmospheric pressure, and sprayed there. The desired super-saturation is achieved by means of the cooling using vacuum application. Subsequently the mass is also tabled in a water-cooled tabling screw. The discharge from the tabling screw takes place by means of a vacuum lock, under vacuum.

Another tabling machine that was developed by the Otto Hänsel company has two screws disposed on top of one another, through which the boiled saccharide solution passes, one after the other. These two screws are cooled, whereby the first screw, which lies on top, is also referred to as a pre-tabling cylinder, in which the hot saccharide solution is cooled and mixed. In this connection, re-crystallization of the saccharose is already supposed to start. This screw is cooled on the inside, to remove heat; the cylinder has mantle cooling. After having passed through the pre-tabling cylinder, the mass is transferred to the second tabling cylinder that lies underneath, which also has mantle cooling and an inner cooling of the tabling screw. The second tabling screw is designed as a transport organ in the intake region, and as a beater vane mechanism in the subsequent region.

The known devices for producing fondant from boiled saccharide solution, which is adjusted to a certain dry substance and water content, respectively, by removing water vapor at atmospheric pressure, on the basis of the boiling temperature, each have a first cooling stage, and a subsequent tabling screw. In this connection, the first cooling stage, for example formed as a cooling drum in the case of Baker Perkins, serves to cool the boiled saccharose solution to a temperature at which the dry substance content corresponds to a super-saturated state. The subsequent tabling screw serves to produce a plurality of crystallization seeds. The heat of crystallization that occurs thereat is removed by means of cooling.

DE 19 23 635 A describes a device for the production of fondant from boiled sugar solution, which device has a cooling and beating mechanism. The reference in DE 19 23 635 to a main patent shows that the boiled sugar solution is cooled to a temperature of 40 to 45 degrees C. before induction of crystallization by means of mechanical stress. In this manner, an under-cooled, i.e. super-saturated solution is first produced, which, in a second processing step, namely in the subsequent beating mechanism through which the solution flows, is transformed to fondant by means of mechanically inducing crystallization. DE 19 23 635 places particular emphasis on gentle treatment of the under-cooled and super-saturated solution. For this purpose the reference provides a heated valve seat around which this super-saturated sugar solution flows.

DE 31 30 968 describes a device and a method for the production of aerated sugar masses, which has two sections through which sugar mass can flow, one after the other, namely a mixing and beating device, as well as a pulling device that is disposed in the exit region of the mixing and beating device. The two sections are formed by different regions of a body having rotation symmetry, which can rotate within a housing. The mixing and beating device forms a working chamber having mixing and beating tools, for example rows or crowns of pins or shovels, which are alternately attached to stator and rotor. The pulling device through which the sugar solution is supposed to flow subsequently is formed by a gap space in the shape of a hollow frustum, alternatively by a cylindrical gap space, which is delimited by circumferential cylinder surfaces.

U.S. Pat. No. 2,197,919 discloses a device for the production of chewing gum or other sweets. This device has two beating mechanisms that follow one another, from which aerated mass is passed into a transport screw for cooling and extrusion.

These known devices assume that for production of fondant, cooling of the saccharide solution to a temperature at which the dry substance content of the saccharide solution represents a super-saturated, unstable state is first required. The desired fine-particle saccharose crystals are subsequently induced by means of violent movement.

The known devices implement methods for producing fondant, in each instance, in which the saccharide solution is cooled after boiling, without any re-crystallization of the saccharose already being intensively excited. In this saccharide solution, which is highly super-saturated and unstable as a result of the lowered temperature, the formation of crystallization seeds can now be induced by means of strong stirring. The tabling screws of the aforementioned known devices are also referred to as beating mechanisms in the technical field, in order to describe their effect in inducing crystallization. The multitude of crystallization seeds that are induced concurrently, if at all possible, prevents the formation of large crystals.

This crude fondant that comes from the tabling machine is still stored for a subsequent, so-called maturation phase of about 24 hours. In this maturation phase, the many crystallization seeds that were induced by means of tabling grow, resulting in solidification of the fondant. The heat of crystallization that is released in this connection keeps the fondant warm for another few hours. Subsequent to this re-crystallization, the fondant becomes softer, since the water re-distributes itself between the crystalline phase and the liquid phase, which has the result that the growth of the crystals is eliminated again subsequent to tabling, by means of re-dissolving.

One way of avoiding the maturation phase of the fondant after inducing crystallization is the division of the boiled stream of the saccharide solution after the boiler, as developed by APV Baker or Baker Perkins, so that approximately two-thirds of the boiled saccharide solution is transformed directly to fondant, while the remaining third is added to the fondant at the exit from the tabling screw as so-called bob syrup. This bob syrup has a higher temperature than the crude fondant. In this manner, the maturation phase that was previously required is supposed to be circumvented, and a fondant is supposed to be obtained that can be passed directly to further processing.

### SUMMARY OF THE INVENTION

It is an object of the present invention to provide a simplified device, as compared with the known state of the art, that is suitable for the continuous production of fondant from boiled saccharide solution. It is a further object of the invention to provide a continuous method for the production of fondant from boiled saccharide solution, with which fondant can be produced with simplified apparatus.

### GENERAL DESCRIPTION OF THE INVENTION

These and other objects are accomplished, according to one aspect of the invention, by providing a device for producing fondant from a saccharide-containing solution, which is still at boiling temperature, i.e. at a temperature above and into the range of its saturation point. As a result, the device according to the invention can be directly charged with saccharide-containing solution, which has a temperature above and into the range of the saturation point. For example, the solution may have boiling temperature in the case of a dry substance content of saccharides of approximately 88-90%. The temperature above or in the range of the saturation point is sufficiently high so that the solution cannot become super-saturated in targeted manner.

In known systems, a cooling stage is provided for cooling the saccharide-containing solution to a temperature in the reliably super-saturated region, i.e. transformation of the boiled saccharide-containing solution into a clearly super-saturated solution. The system of Baker Perkins provides a cooling drum for this purpose, and the system known from Otto Hänsel provides the first cooling screw for pre-tabling. This approach is in harmony with the original production of fondant by hand, in which the crystal formation of a cooled super-saturated solution is induced by means of violent movements with a spatula on a marble slab.

In contrast, the invention surprisingly shows that a separate device for cooling of the saccharide-containing solution to a temperature at which a reliably super-saturated state exists is not required before inducing crystallization.

The separate cooling device for cooling the saccharide-containing solution, after it has boiled, to a temperature below its saturation point, i.e. cooling of the solution that contains saccharide to a temperature at which it is present in a reliably super-saturated state, on the basis of its dry substance content, which is present in the state of the art as discussed above, is not present in the case of the device according to the invention.

In contrast to the state of the art, the device according to the invention for producing fondant makes it possible to transform the saccharide-containing solution to fondant, which is suitable for further processing, directly, at a temperature above or in the range of its saturation point.

For cooling the boiled saccharide solution after boiling, and for the induction of crystallization, the device according to the invention has only a transport screw having a cooled stator and rotor, by means of which the saccharide-containing solution is transformed into fondant directly, without pre-cooling, in one processing step. The inside surface of the stator is cylindrical; the rotor has a spiral that is a single or multiple spiral, preferably a double spiral.

The known systems for producing fondant necessarily have regions in which saccharide solution that has started to crystallize is not reliably transported by force, particularly due to the multi-stage treatment. This arrangement has the result that individual crystals that are already present can clearly dwell here longer, while they are surrounded by a super-saturated saccharose solution so that they necessarily grow in an uncontrolled manner. Crystals up to several 100 μm were found, which had been caused by this uncontrolled growth, and these crystals result in a loss in quality of the fondant that is obtained.

The device according to the invention has another advantage in that in contrast to the known systems, guidance of the product in the device according to the invention does not permit any uncontrolled dwell time and therefore no uncontrolled growth of saccharose crystals.

The transport screw according to the invention preferably has a ratio of the length of stator and rotor that is effective for heat transfer relative to the inside diameter of the stator, and to the outside diameter of the rotor, respectively, between 8 and 10, preferably between 8.5 and 9.5. The dimensioning of rotor and stator is designed, according to the invention, by means of adapting the available heat transfer surface of the stator and the rotor to the temperature gradient of the cooling water relative to the saccharide-containing solution, so that cooling of the saccharide-containing solution from the entry temperature at above the saturation point to approximately 55 to 65° C., preferably approximately 60° C., is achieved. In this connection, the device is dimensioned so that heat of crystallization that is released is also removed.

The speed of rotation of the rotor must be taken into consideration as another influence factor on the grain size of the fondant. In the preferred embodiment, the rotor can be adjustably driven by a motor, at speeds of rotation in the range between 100 to 500 rpm, preferably between 200 and 350 rpm.

On the basis of the aforementioned parameters, a person skilled in the art is able to construct a device according to the invention of suitable dimensions. As a point of departure, a device according to an embodiment of the invention may be dimensioned to have a throughput of the dry substance of approximately 500 kg per hour.

At a throughput of approximately 500 kg/h, the length of the stator and rotor effective for heat transfer for a device according to the invention amounts to 1500 to 2500 mm, preferably approximately 2000 mm. The length between the entry opening and exit opening in the stator, which is also filled by the rotor, is referred to as the length effective for heat transfer.

In this connection, the rotor has an outside diameter of 200 to 250 mm at a wall thickness of 10 to 30 mm, measured including the height of the spiral.

In a preferred embodiment, the annular gap between rotor and stator, measured from the spiral height, is 1 to 10 mm, preferably 2 to 5 mm.

The device according to the invention permits a process for the production of fondant from saccharide-containing solution, which has a temperature in the range of its saturation point, in only one processing step. It was found that a saccharide-containing solution can be allowed to enter the entry opening of the stator immediately subsequent to boiling at 115 to 125 degrees C. and after evaporation of the water vapors, at atmospheric pressure. The temperature of the fondant at the exit opening was measured to approximately 60 to 65 degrees C.

The fondant produced using the device according to the invention demonstrates a stable distribution of the grain sizes immediately after production and also after a storage period of 24 hours, which lies essentially in the range around 10 μm. The fondant so obtained was suitable for direct further processing or for storage, and corresponds to the demands on a high-quality fondant in the sensory test.

Therefore, the device according to the invention allows the production of stable fondant in a single apparatus, directly from saccharide-containing solution that has a temperature above or in the range of its crystallization point, for example boiling temperature. A separate cooling device for under-cooling the saccharide-containing solution subsequent to boiling, to a temperature below its saturation point, is therefore not required in the device according to the invention. Therefore, this separate cooling device is also not contained in the device according to the invention.

In a preferred embodiment, the device according to the invention is dimensioned, with regard to cooling of rotor and stator, so that these allow a through-flow of coolant that is sufficient to allow a temperature gradient of maximally 10 degrees C., preferably maximally 5 degrees C., particularly preferably maximally 1 to 2 degrees C., by way of the length of rotor and stator that is effective for heat transfer. This temperature gradient by way of the length of rotor and stator that is effective for heat transfer can be determined as heating of the coolant on the basis of the passage through rotor and stator. In a further preferred embodiment, the coolant flow through rotor and stator is passed in counter-current to the passage of the saccharide solution. A preferred coolant is water.

In another preferred embodiment, the coolant flow that passes through rotor and stator, in each instance, is adjusted to the same entry temperature.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 represents a schematic cross-sectional view of the device according to the invention; and

FIG. 2 shows the detail A from FIG. 1, in cross-section, on an enlarged scale.

### DETAILED DESCRIPTION OF PREFERRED EMBODIMENTS

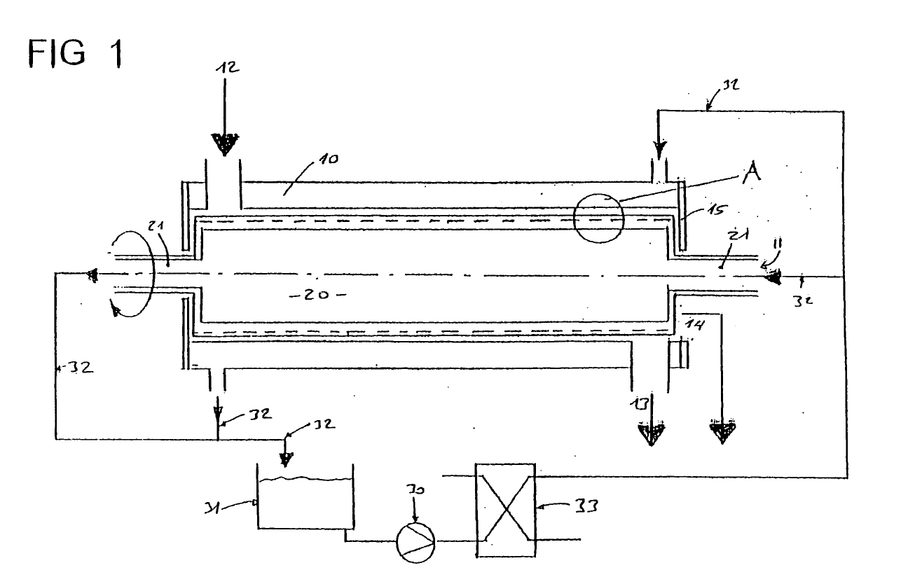

Turning now in detail to the drawings, as shown in FIG. 1, the device according to the invention has a stator 10, in which a rotor 20 is mounted to rotate axially. Stator 10 has a double mantle for tempering, i.e. for cooling, by means of water, for example; rotor 20 is hollow on the inside and coolant can flow through it in operation, through the passage openings 11 for coolant in the bearing journals 21.

Rotor 20 is put into rotation by means of a motor (not shown). Boiled saccharide-containing solution can be passed into the gap between rotor 20 and stator 10 through the entry opening 12 of stator 10, and exit through one of the two alternative exit openings 13 or 14. In this connection, exit opening 13 is disposed in stator 10 radially or tangentially to rotor 20. The preferred exit opening 14 is disposed axially to rotor 20. For the case of the radial or tangential exit opening 13, the axial end plate 15 is configured so that stator 10 is closed off axially on both sides.

Preferred exit opening 14 can be represented, for example, in the form of an opening in axial end plate 15, which closes off stator 10 at its end, with exit opening 14. For exit opening 14 that is disposed axially, the opening in axial end plate 15 amounts to at least ten percent of the covered area of the annular gap between rotor 20 and stator 10, preferably 20 to 50% or above. In this connection, it is also possible to configure axial end plate 15 such that the cross-sectional area of the annular gap between stator 10 and rotor 20 is covered only up to a small extent, for example up to 50%, preferably up to 30%, particularly preferably up to 10%, so that fondant can exit from the device axially, essentially without deflection.

The axial arrangement of the exit opening is shown schematically as exit opening 14. The axial arrangement of exit opening 14 permits the exit of fondant at a lower temperature than is allowed by the tangentially disposed exit opening 13, as a particular advantage.

In the preferred embodiment of the invention, the device has such cross-sections of the coolant lines and such dimensioning of the double mantle of the stator, and also of the inside volume of the rotor, that a coolant through-flow through rotor and stator can be adjusted that is sufficient to allow a temperature gradient, over the length of rotor and stator that is effective for heat transfer, that amounts to maximally 10 degrees C., preferably maximally 5 degrees C., particularly preferably maximally 2 degrees C. The method for the production of fondant that is carried out using the device according to the invention is therefore also preferably carried out with a maximal temperature gradient, over the length of rotor and stator that is effective for heat transfer, of 10 degrees C., preferably maximally 5 degrees C., particularly preferably maximally 2 degrees C. A person skilled in the art is able to calculate the necessary coolant flow with which the temperature gradient required according to the preferred embodiment can be adjusted. In this connection, the amount of heat to be transported off that is composed of the temperature reduction of the saccharide-containing solution during fondant production, as well as the heat of crystallization that is released, must be taken into consideration, plus the heat energy introduced by means of rotation of the rotor. With regard to the dimensioning of the cross-sections of coolant lines, cross-sectional area of the double mantle of the stator, as well as the cross-sectional area of the inside volume of the rotor, not only the heat capacity of the coolant but also the heat conduction coefficients and heat transfer coefficients that determine the heat transfer from the saccharide-containing solution into the coolant must be taken into consideration.

It is particularly preferred to dispose the device according to the invention as a module in combination with an independent internal cooling system. Such a cooling system uses coolant lines 32, through which the coolant is circulated by means of a circulation pump 30, both through the double mantle of stator 10, and through the inside volume of the hollow rotor 20. In this connection, the coolant is preferably guided, both in stator 10 and in rotor 20, in counter-current to the general flow direction of the fondant, from entry opening 12 to exit opening 13, 14. The coolant circulation system has a reservoir or an equalization container 31 that can also serve as a central container for coolant after it has passed through stator 10 and/or rotor 20. It is advantageous if no consumption of the coolant that flows in the circulation system takes place.

The heat conducted away from stator 10 and rotor 20 is passed away from the module by means of a heat exchanger 33, which can be a plate heat exchanger or a pipe bundle heat exchanger. Such a module offers the advantage that the tempering of the device according to the invention for fondant production can be controlled independent of the temperature of the operational coolant water that is available, in a proprietary system.

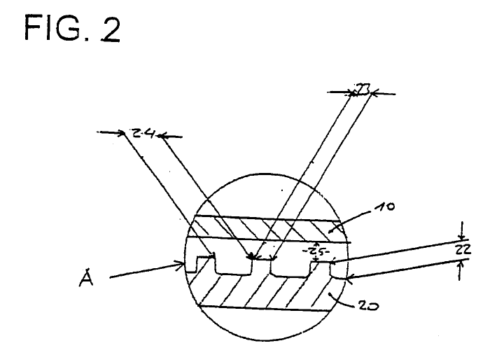

As shown in detail in FIG. 2, the annular gap between stator 10 and rotor 20 is determined by the spiral worked into rotor 20 and the inside of stator 10. Preferably, rotor 20 has a spiral with two threads, the spiral height 22 of which lies in the range of 5 to 20 mm, preferably 5 to 15 mm. The spiral width 23 is 5 to 30 mm here, preferably 15 to 25 mm. The spiral distance 24 is preferably 5 to 20 mm. The gap 25 between spiral height 22 and the inside of stator 10 is 1 to 10 mm, preferably 2 to 5 mm.

Stator 10 has a cylindrical, smooth inside surface. Preferably, the taps for supplying and discharging coolant are disposed in entry opening 12 tangentially to stator 10.

### EXAMPLE

### Production of Fondant Using the Device According To the Invention

Saccharide-containing solution was batched up from 100 kg crystal sugar (saccharose), 20 kg glucose syrup, with 30 liters solution water, and heated to a final temperature of 118-121 degrees C. in a continuously operating boiler having steam heating. Immediately subsequent to boiling, the saccharide-containing solution was allowed to volatilize into an evaporating container, under atmospheric pressure; the water vapors that formed were conducted off. Under these conditions, a dry substance content of the finished, boiled saccharide-containing solution of approximately 88-90% is adjusted.

The volatilized solution that contains saccharide was passed to entry opening 12 of the device according to the invention, which was disposed essentially horizontally, by way of a feed tube. As an alternative to a simple feed tube without tempering, the feed tube could be heated with steam at the same pressure as the boiler.

Coolant water was circulated through the double mantle of stator 10 as well as the interior of rotor 20, in counter-current, the coolant water temperature being approximately 20 to 30 degrees C. The temperature gradient over the length of rotor and stator that is effective for heat transfer, measured as heating of the coolant water after passage through rotor and stator, was maximally 2 degrees C.

In the case of a supplied mass stream of approximately 500 kg per hour dry substance of the solution supplied, the temperature of which lay in the range of its crystallization point, it was possible to produce fondant continuously. The exit temperature of the fondant was between 60 and 65 degrees C. and could be influenced by variation of the speed of rotation of rotor 20, the flow-through amount of the coolant water, and the coolant water temperature.

Fondant produced according to the invention had an average grain size of 10 μm at microscopical viewing, with a very small proportion of larger crystals. The sensory test showed that fondant produced according to the invention was pleasantly smooth and flexible. These properties were determined both immediately after production and also subsequent to a storage period of 24 hours at room temperature.

Although only a few embodiments of the present invention have been shown and described, it is to be understood that many changes and modifications may be made thereunto without departing from the spirit and scope of the invention as defined in the appended claims.

### LIST OF REFERENCE NUMERALS

10 stator
11 passage openings for coolant water
12 entry opening
13 exit opening
14 axial exit opening
20 rotor
21 bearing journal
22 spiral height of the rotor
23 spiral width of the rotor
24 spiral distance of the rotor
25 distance between spiral height-stator
30 circulation pump
31 equalization container
32 coolant water line
33 heat exchanger

1. A device for continuous production of fondant from a saccharide-containing solution, the solution having a temperature above or within a range of a saturation point of the solution, the device comprising a single transport screw having a cooled stator and a cooled rotor for cooling the saccharide-containing solution and for inducing crystallization.

2. The device according to claim 1, wherein said transport screw has a discharge opening disposed axially in the stator.

3. The device according to claim 2, wherein the discharge opening comprises an opening in an axial end plate that covers a cross-sectional area of an annular gap between said stator and said rotor by maximally 50%.

4. The device according to claim 1, wherein the rotor has a multiple spiral or a double spiral.

5. The device according to claim 1 further comprising a feed line for passing the saccharide-containing solution from a boiler to an entry opening of the transport screw, said feed line being double-walled and adapted to be heated with steam or pressurized water.

6. The device according to claim 1, wherein the device is dimensioned to accommodate a coolant through-flow through said rotor and said stator sufficient to adjust a temperature gradient over the length of said rotor and said stator that is effective for heat transfer of maximally 10 degrees C.

7. The device according to claim 6, wherein the temperature gradient is maximally 5 degrees C.

8. The device according to claim 1 further comprising a separate coolant circulation system for cooling said rotor and said stator.

9. The device according to claim 8, wherein the coolant circulation system has a circulation pump, an equalization container, a heat exchanger, and a plurality of lines for circulating coolant through said rotor and said stator.

10. The device according to claim 9, wherein the circulation pump is disposed so that the coolant can flow in counter-current to the saccharide-containing solution.

11. The device according to claim 6, wherein the ratio of the length of the stator effective for heat transfer to an inside diameter of said stator, and the ratio of the length of the rotor effective for heat transfer to an outside diameter of said rotor, lies between 8.5 and 9.5.

12. The device according to claim 1, wherein said rotor and said stator are separated by a minimal distance of 1.5 to 5 mm.

13. A method for producing fondant from a saccharide-containing solution having a temperature above or within a range of a saturation point of the solution comprising the following steps:
(a) providing a device comprising a single transport screw having a cooled stator and a cooled rotor for cooling the saccharide-containing solution and for inducing crystallization; and
(b) using the device at atmospheric pressure to produce fondant from the solution.
